(19) United States
(12) Patent Application Publication
(10) Pub. No.: US 2019/0210449 A1
(43) Pub. Date: Jul. 11, 2019

(54) DRIVE TRAIN FOR A MOTOR VEHICLE, AND METHOD FOR OPERATING A DRIVE TRAIN

(71) Applicant: Schaeffler Engineering GmbH, Werdohl (DE)

(72) Inventors: Ingo Schulz, Eschweiler (DE); Marco Happe, Herzogenrath (DE); Stephan Zieger, Aachen (DE)

(21) Appl. No.: 16/323,825

(22) PCT Filed: Aug. 4, 2017
(86) PCT No.: PCT/DE2017/100664

§ 371 Date: Feb. 7, 2019

(30) Foreign Application Priority Data
Aug. 8, 2016 (DE) 10 2016 214 688.2

(51) Int. Cl. B60K 6/387; B60K 6/547; B60K 6/365; B60K 6/48; F16H 3/093

(52) U.S. Cl. CPC B60K 6/387; B60K 6/547; B60K 6/365; B60K 6/48; F16H 2200/0043; B60K 2006/4816; B60K 2006/4841; F16H 2003/0931; F16H 3/093

(57) ABSTRACT

The invention relates to a drive train (1) for a motor vehicle, having an infernal combustion engine (2), an automated manual transmission (3), an electric machine (4), a shiftable separating clutch (5) for selectively making a power flow possible between the electric machine (4) and the internal combustion engine (2), and an differential gear (20), wherein the internal combustion engine (2) has an output shaft (2.1) that is coupled without a separating clutch to a first transmission input shaft (10) of the automated manual transmission (3), wherein the automated manual transmission (3) has a first transmission output shaft (11) and a second transmission output shaft (12) that are operatively connected to a differential drive gear (19) of the differential gear (20), wherein the separating clutch (15) is situated coazially with respect to a clutch shaft (15) that is connected to the separating clutch (5) and is spaced apart from and in parallel to the first transmission input shaft (10), wherein the clutch shaft (15) is spaced apart from and an parallel to the first transmission output shaft (11) and the second transmission output shaft (12).

### FIELD OF THE INVENTION

The invention relates to a drive train for a motor vehicle, having an internal combustion engine, an automated manual transmission, an electric machine, a shiftable separating clutch for selectively making a power flow possible between the electric machine and the internal combustion engine, and a differential near, wherein the internal combustion engine has an output shaft that is coupled without a separating clutch to a first transmission input shaft of the automated manual transmission, wherein the automated manual transmission has a first transmission output shaft and a second transmission output shaft that are operatively connected to a differential drive gear of the differential gear.

The invention further relates to a method for operating a drive train of this type.

### PRIOR ART

Such drive trains are also referred to as hybrid drive trains, and may be used in motor vehicles, for example passenger vehicles.

A drive train is known from DE 10 2014 222 587 A1, which in addition to an internal combustion engine and an electric machine has an automated manual transmission. The internal combustion engine includes an output shaft that is coupled to a transmission input shaft via a dual-mass flywheel. A separating clutch for disconnecting the output shaft from the transmission input shaft is not provided. In this regard, these shafts are coupled to one another without a separating clutch. In this drive train, the electric machine is situated coaxially with respect to the internal combustion engine. To selectively make a power flow possible between the electric machine, and the internal combustion engine, the drive train also has a separating clutch that is connected to the first transmission input shaft and situated coaxially with respect to same.

In this drive train, it has proven disadvantageous that a relatively large installation space is necessary in the axial direction of the output shaft of the internal combustion engine. This may be a drawback in particular in installation situations in which the output shaft of the internal combustion engine is to be installed in a direction transverse to the longitudinal axis of the motor vehicle.

Another drive train that requires a relatively large installation space in the axial direction is known from DE 10 2012 016 990 A1. This drive train includes an internal combustion engine whose output shaft is connected without a separating clutch to a transmission input shaft of an automated manual transmission. An electric machine is situated coaxially with respect to the output shaft of the internal combustion engine. The automated manual transmission has two transmission output shafts that are operatively connected to a differential drive gear of a differential gear. For selectively coupling the electric machine to the internal combustion engine, a shiftable separating clutch is provided coaxially with respect to the first transmission input shaft.

In addition, DE 10 2013 215 114 A1 describes a drive train having an internal combustion engine, an electric machine, and an automated manual transmission, in which the internal combustion engine is coupled to a transmission input shaft of the automated manual transmission via a separating clutch. DE 10 2013 215 114 A1 describes that the separating clutch between the output shaft of the internal combustion engine and the transmission input shaft may be dispensed with. For start-up, the output shaft of the internal combustion engine and the machine shaft of the electric machine may be connected via shiftable clutches of the automated manual transmission that are situated coaxially with respect to a transmission output shaft of the manual transmission and connected to a planetary gear. However, this results in a relatively large installation space requirement in the axial direction of the transmission output shaft.

### SUMMARY OF THE INVENTION

The object of the present invention is to enable a compact design of the drive train.

In a drive train oaf the type stated at the outset, the object is achieved in that the separating clutch is situated coaxially with respect to a clutch shaft that is connected to the separating clutch and is spaced apart from and in parallel to the first transmission input shaft, wherein the clutch shaft is spaced apart from and in parallel to the first transmission output shaft and the second transmission output shaft.

In the drive train according to the invention, the internal combustion engine is coupled to the automated manual transmission without providing a separating clutch for disconnecting the internal combustion engine from the automated manual transmission. The output shaft of the internal combustion engine is in continuous operative connection with the input shaft of the automated manual transmission. For selectively disconnecting and connecting the electric machine from the internal combustion engine, the drive train has a separating clutch that is connected to a clutch shaft and is spaced apart from and in parallel to the first transmission input shaft. This clutch shalt is also spaced apart from and in parallel to the first transmission output shaft and the second transmission output shaft. As a result of these measures, the required installation space for the drive train in the axial direction of the output shaft of the internal combustion engine may be reduced, thus enabling a compact design of the drive train.

Within the meaning of the invention, a shiftable separating clutch is regarded as a shiftable separating clutch that is designed to be separate from the automated manual transmission. In particular, the clutch shaft connected to the shiftable separating clutch is designed to be separate from the automated manual transmission. The clutch shaft is particularly preferably spaced apart from and in parallel to all transmission input shafts and transmission output shafts of the automated manual transmission.

The shiftable separating clutch is preferably designed as a force-locked, in particular friction-locked, shiftable separating clutch. The shiftable separating clutch may have two or more friction surfaces that are brought into contact with one another to transmit a torque. The shiftable separating clutch is particularly preferably designed as a multi-plate clutch having multiple friction surfaces connected in parallel.

The drive, train preferably has one separating clutch, so that installation space and costs for additional separating clutches and their actuating devices may be saved.

The automated manual transmission may have two partial transmissions, a first partial transmission being associated with the internal combustion engine and having the first transmission input shaft, and a second partial transmission being associated with the electric machine and having a second transmission input shaft. The separating clutch is preferably situated in such a way that an in particular bidirectional operative connection between the first transmission input shaft and the second transmission input shaft may be selectively established or separated

According to the invention, the automated manual transmission has a first transmission output shaft and a second transmission output shaft that are operatively connected to a differential drive gear of a differential gear. The first and second transmission output shafts may have shiftable wheel sets via which multiple gears of the automated manual transmission may be realized. For example, the first transmission output shaft may have at least two wheel sets for a first and a second gear, and the second transmission output shaft may have at least two wheel sets for a third and a fourth pear. The wheel sets may each have a fixed wheel that is nonrotatably connected to the respective transmission output shaft, and two idler wheels that are selectively coupleable to the fixed wheel in order to select a gear. The idler wheels are preferably engaged with fixed wheels of the transmission input shaft. The output power of the first transmission output shaft and of the second transmission output shaft may be delivered via the differential drive gear. The first transmission output shaft preferably has a first fixed wheel that is engaged with the differential drive gear, and the second transmission output shaft preferably has a second fixed wheel that likewise is engaged with the differential drive gear. The fixed wheels are preferably designed as gearwheels.

In this regard, it is advantageous when the differential drive gear of the differential gear is engaged with exactly two gearwheels in order to establish the operative connection with the first transmission output shaft and the second transmission output shaft. In this way, greater design flexibility may be achieved compared to the drive train previously known from DE 10 2014 222 587 A1. The gearwheels may be situated either on a first side of the two transmission output shafts, or on a second side of the transmission output shafts opposite from the first side, so that the differential gear in the drive train may be situated either on the first side or on the second side of the transmission output shafts.

According to one advantageous embodiment, it is provided that the automated manual transmission has a second transmission input shaft that is coupled without a separating clutch to the machine shaft of the electric machine, wherein the automated manual transmission has a shiftable gearwheel stage via which the second transmission input shaft is coupleable to the first transmission output shaft or the second transmission output shaft. A power flow between the electric machine and the respective transmission output shaft or the differential may selectively made possible by means of the shiftable gearwheel stage. It is thus possible to drive the drive wheels during an acceleration operation, or to feed back energy during a braking operation, via the electric machine. For connecting the electric machine to the differential, an additional transmission output shaft with an additional fixed wheel that engages with the differential drive gear, which is provided, for example, in the drive train known from DE 10 2014 222 587 A1, is not necessary. The differential drive gear is preferably engaged only with the first fixed wheel of the first transmission output shaft and the second fixed wheel of the second transmission output shaft, so that no further gearwheels are engaged with the drive wheel of the differential. Gearwheel tooth wear, in particular under full load, may thus be reduced and the service life of the drive wheel may be increased. In addition, it is not necessary to compensate for a possible increase in gearwheel tooth wear via design measures, such as increased tooth width, which entails increased axial installation space, or decreased shaft spacing.

The clutch shaft is preferably spaced apart from and in parallel to the second transmission input shaft of the automated manual transmission. It is particularly preferred that the first transmission input shaft, the second transmission input shaft, the first transmission output shaft, and the second transmission output shaft are each spaced apart from and in parallel to one another.

In this regard, it has proven to be preferable for the second transmission input shaft to be coupled to the machine shaft of the electric machine via a planetary gear, so that the electric machine may be operated in a speed range that is advantageous for the electric machine, and that differs from the speed range of the second transmission input shaft. Alternatively, the second transmission input shaft may be nonrotatably connected to the machine shaft of the electric machine, so that the second transmission input shaft is operated at the same speed as the machine shaft.

According to one alternative advantageous embodiment, it is provided that the automated manual transmission has a gearwheel stage via which the clutch shaft is coupled to the first transmission output shaft or the second transmission output shaft. A power flow between the clutch shaft and the respective transmission output shaft or the differential is made possible by means of the gearwheel stage, so that the drive wheels may be driven during an acceleration operation, or energy may be fed back during a braking operation, via the electric machine. The electric machine may be selectively connected to the clutch shaft, and thus also to the respective transmission output shaft, via the separating clutch that is connected to the clutch shaft. For connecting the electric machine to the differential, an additional transmission output shaft with an additional fixed wheel that engages with the differential drive gear, which is provided, for example, in the drive train known from DE 10 2014 222 587 A1, is not necessary. The differential drive gear is preferably engaged only with the first fixed wheel of the first transmission output shaft and the second fixed wheel of the second transmission output shaft, so that no further gearwheels are engaged with the drive wheel of the differential. The service life of the drive wheel may be increased in this way.

According to one advantageous embodiment of the invention, it is provided that the output shaft of the internal combustion engine is coupled to the transmission input shaft via a vibration damper. The transmission of rotary vibrations, generated by the internal combustion engine, for example, to the automated manual transmission may be damped by means of the vibration damper. The vibration damper is preferably designed as a dual-mass flywheel. The dual-mass flywheel may have a first flywheel mass and a second flywheel mass that are coupled by spring-damper units.

One advantageous embodiment of the invention provides that the clutch shaft is situated coaxially with respect to a machine shaft of the electric machine. During operation of the electric machine as an electric motor, the machine shaft forms an output shaft of the electric machine. When the electric machine is operated as a generator, the machine shaft forms a drive shaft of the electric machine. The clutch shaft may be coupled to the machine shaft via a gear stage, for example.

One alternative advantageous embodiment provides that the clutch shaft is spaced apart from and in parallel to a machine shaft of the electric machine, as the result of which the dimensions of the drive train may be further reduced in the axial direction.

The clutch shaft is preferably coupled to the electric machine via a planetary gear. A speed adjustment may be made via the planetary gear, so that the electric machine may be operated in a speed range that is advantageous for the electric machine, and that is different from a speed range of the clutch shaft in addition, the planetary gear allows the coaxial arrangement of a drive and an output of the planetary gear. The planetary gear is particularly preferably designed in such a way that it allows a step-up of a higher speed of the electric machine, in particular the machine shaft of the electric machine, into a lower speed of the clutch shaft.

According to one advantageous embodiment, the first transmission input shaft is coupled to the separating clutch, in particular via a gearwheel stage, so that a power flow is made possible between the first gear shaft on the internal combustion engine side and the separating clutch, which is spaced apart from the first gear shaft. The first near shaft may be selectively disconnected from the electric machine, in particular the machine shaft of the electric machine, or connected thereto, via the separating clutch. The gearwheel stage preferably has a first gearwheel that is situated on the first transmission input shaft, and a second gearwheel that as connected to the separating clutch and is engaged with the first gearwheel. The first gearwheel may be designed as a fixed wheel of the first transmission input shaft; the second gearwheel may be designed as an idler wheel of the clutch shaft. The coupling of the first transmission input shaft to the separating clutch may additionally take place via the clutch shaft. In this case, the second gearwheel of the gearwheel stage may be designed as a fixed wheel of the clutch shaft.

Moreover, to achieve the object stated at the outset, a method for operating a drive train of a motor vehicle is proposed, having an internal combustion engine and an automated manual transmission, wherein the internal combustion engine has an output shaft that is coupled without a separating clutch to a first transmission input shaft of the automated manual transmission, wherein the automated manual transmission has a first transmission output shaft and a second transmission output shaft that are operatively connected to a differential drive gear of a differential gear, and an electric machine, wherein for selectively making a power flow possible between the electric machine and the internal combustion engine, a shiftable separating clutch that is situated coaxially with respect to a clutch shaft and spaced apart from and in parallel to the first transmission input shaft is actuated, wherein the clutch shaft is spaced apart from and in parallel to the first transmission output shaft and the second transmission output shaft.

The same advantages may be achieved with the method as already discussed in conjunction with the drive train according to the invention.

The automated manual transmission preferably has two partial transmissions, a first partial transmission being associated with the internal combustion engine and having the first transmission input shaft, and a second partial transmission being as with the electric machine and having a second transmission input shaft, and an in particular bidirectional operative connection between the first transmission input shaft and the second transmission input shaft being selectively established or separated by actuating the separating clutch.

According to one advantageous embodiment, the two partial transmissions have shiftable gears that may selectively be actively or nonactively shifted. For an actively shifted gear, a torque may be transmitted to a transmission output shaft associated with the gear. If no gear of one of the two partial transmissions is actively shifted, no torque is transmitted. The shifting of these gears preferably takes place by interrupting the tractive force of a partial transmission, as the result of which the respective other partial transmission in the shifting phase maintains the drive tractive force to allow a driving feel that is free of tractive force interruption. The shifting of a shift stage is preferably carried out by a synchronization unit, in which the differential speed is reduced by friction cones. Alternatively, the shifting may be carried out by a claw clutch, with the speed adjustment taking place by means of the internal combustion engine or the electric machine. The required axial installation space. is further reduced by use of a pure claw clutch.

According to one advantageous embodiment, the separating clutch is disengaged, with active shifting of a gear in each case in the first partial transmission and in the second partial transmission. An operating state may thus be set in which the internal combustion engine as well as the electric machine are operatively connected to a differential via the automated manual transmission. When the separating clutch is disengaged, the internal combustion engine and the electric machine can transmit torque to the differential. Alternatively, the electric machine may be operated as a generator. This takes place by setting the drive torque of the internal combustion engine in such a way that an acceleration specified by the driver of the vehicle is achieved, and a generator torque is supplied to the electric machine with an excess torque that is a function of the torque characteristic map of the internal combustion engine. In addition, a generator torque of the electric machine may assist the braking operation during a deceleration operation of the vehicle. When the separating clutch is disengaged, it is also possible to use the electric machine in the so-called boost mode, in which the drive torque is temporarily increased. The state of charge of the battery and the heating of the electric machine determine the frequency and intensity of the boost mode.

Various start-up strategies that may he selectively carried out are described below.

According to one preferred embodiment of the method, the purely electric start-up, the drive tommie of the electric machine is applied to a transmission output shaft via an actively shifted gear of the second, electric motor partial transmission. The electric machine hereby allows generation of a drive torque with the drive shaft idle, so that no starting clutch is necessary.

According to an alternatively preferred embodiment of the method, the purely internal combustion engine start-up, all gears of the first, internal combustion engine partial transmission are nonactively shifted, and a gear of the electric motor partial transmission is actively shifted, wherein as the result of in particular controlled engagement of the separating clutch, power is transmitted from the internal combustion engine, via the separating clutch, to the second, electric motor transmission input shaft, and via the actively shifted gear of the second partial transmission is transmitted to the differential. The electric machine may optionally be entrained without power, or as a generator may charge the battery or assist the start-up operation.

According to one advantageous embodiment of the method, the separating clutch is engaged in order to start the internal combustion engine, wherein all gears are nonactively shifted in each case in the first partial transmission and in the second partial transmission, thus allowing a cold start of the internal combustion engine by the electric machine. The power flow takes place from the machine shaft of the electric machine, via the engaged separating clutch, to the first, internal combustion engine transmission input shaft, which is coupled to the internal combustion engine. The engine may be started when the ignition speed is reached.

According to another advantageous embodiment of the method, in electric motor operation, no gears of the first, internal combustion engine partial transmission are actively shifted, and the internal combustion engine is idle. To start the internal combustion engine in this phase, the separating clutch may be engaged in order to connect with slip the second, electric motor transmission input shaft, under drive torque, via the separating clutch to the stationary first transmission input shaft until the ignition speed is reached.

The advantageous features and embodiments described in conjunction with the drive train may likewise find application, as an alternative or in combination, in the method.

### BRIEF DESCRIPTION OF THE FIGURES

Further advantages and particulars are explained below with reference to one exemplary embodiment illustrated in the drawings, which show the following:

FIG. 1 shows a drive train for a motor vehicle according to a first exemplary embodiment of the invention in a schematic illustration;

FIG. 2 shows the drive train according to FIG. 1 in a schematic sectional illustration;

FIG. 3 shows the drive train according to FIG. 1 in a block diagram;

FIG. 4 shows a drive train for a motor vehicle according to a second exemplary embodiment of the invention in a schematic illustration;

FIG. 5 shows the drive train according to FIG. 4 in a schematic sectional illustration;

FIG. 6 shows a drive train for a motor vehicle according to a third exemplary embodiment of the invention in a schematic illustration;

FIG. 7 shows the drive train according to FIG. 6 in a schematic sectional illustration; and

FIG. 8 shows a drive train for a motor vehicle according to a fourth exemplary embodiment of the invention in a schematic illustration.

### EMBODIMENTS OF THE INVENTION

Identical parts are always provided with the same reference numerals in the various figures, and therefore are generally designated or mentioned only once in each case.

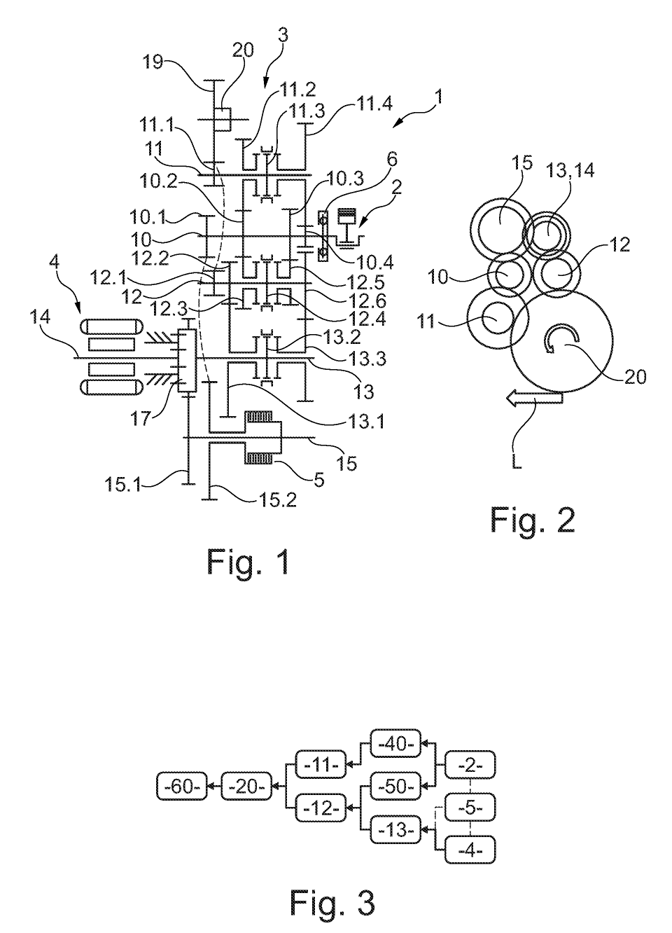

FIG. 1 illustrates a first exemplary embodiment of a drive train that may be used in a hybrid motor vehicle. The drive train 1 has an internal combustion engine 2, a manual transmission 3, an electric machine 4, and a separating clutch 5. As explained in greater detail below, in an engaged state of the separating clutch 5 a power flow may be made possible between the electric machine 4 and the internal combustion engine 2. In a disengaged state of the separating clutch 5, the electric machine 4 and the internal combustion engine 2 are decoupled from one another.

The internal combustion engine 2 has an output shaft 2.1 that is connected without a separating clutch to a first transmission input shaft 10 of the manual transmission 3. This means that the output shaft 2.1 and the first transmission input shaft 10 are in continuous operative connection, and selective separation of this connection is not possible. A vibration damper 6 designed as a dual-mass flywheel is situated between the output shaft 2.1 and the first transmission input shaft 10. The output shaft 2.1 and the first transmission input shaft 10 are situated coaxially with respect to one another. The output shaft 2.1 and the first transmission input shaft 10 are preferably installed in the motor vehicle in a transverse direction that is perpendicular to the vehicle longitudinal direction L. The vibration damper is provided coaxially with respect to the output shaft 2.1 and the first transmission input shaft 10.

The first transmission input shaft 10 is nonrotatably connected to a fixed wheel 10.1, which is engaged with an idler wheel 15.2 of a clutch shaft 15. The fixed wheel 10.1 is designed as a gearwheel. The idler wheel 15.2 is connected to the separating clutch 5. The idler wheel 15.2 is selectively coupleable via the separating clutch 5 to the clutch shaft 15, which is situated coazially with respect to the separating clutch 5. The clutch shaft 15 is connected to a machine shaft 14 of the electric machine 4 via a planetary gear 17. The clutch shaft 15 and the machine shaft 14 are spaced apart from one another in parallel. According to the invention, the separating clutch 5 is situated coaxially with respect to the clutch shaft 15, which is spaced apart from and in parallel to the first transmission input shaft 10. The required installation space in the transverse direction of the motor vehicle is thus reduced. In addition, the electric machine 4 is not situated coaxially with respect to the internal combustion engine 2, so that the diameter of the electric machine 4 may he set independently of the size of the internal combustion engine 2. It is thus also possible to select the electric machine 4 depending on the application (microhybrid, mild hybrid, full hybrid), without having to make changes to the manual transmission.

The manual transmission 3, in addition to the first transmission input shaft 10, has a first transmission output shaft 11, a second transmission output shaft 12, and a second transmission input shaft 13, each being spaced apart from and in parallel to one another (also see FIG. 2). Three additional fixed wheels 10.2, 10.3, 10.4, via which the first transmission input shaft 10 may be coupled to the first transmission output shaft 11 and/or the second transmission output shaft 12, are nonrotatably situated on the first transmission input shaft 10.

A second fixed wheel 10.2 of the first transmission input shaft 10 is engaged with a first idler wheel 11.2 of the first transmission output shaft 11. A further fixed wheel 10.4, referred to below as the fourth fixed wheel 10.4, is engaged with a second idler wheel 11.4 of the first transmission output shaft 11. The second idler wheel 11.4 may be coupled to a fixed wheel 11.3 that is nonrotatably connected to the first transmission output shaft 11 in order to activate a first gear of the manual transmission 3. Alternatively, the fixed wheel 11.3 may be coupled to the first idler wheel 11.2 of the first transmission output shaft 11, so that a second gear of the manual transmission 3 is activated. A further fixed wheel 11.1 of the first transmission output shaft 11 is engaged with a drive wheel 19 of a differential gear 20.

The second fixed wheel 10.2 of the first transmission input shaft 10 is also engaged with a first idler wheel 12.3 of the second transmission out shaft 12. A third fixed wheel 10.3 of the transmission input shaft 10 is engaged with a second idler wheel 12.5 of the second transmission output shaft 12. The first idler wheel 12.3 of the second transmission output shaft 12 may be connected to a fixed wheel 12.4 of the second transmission output shaft 12 in order to activate a third gear. The second idler wheel 12.5 of the second transmission output shaft 12 may be connected to the fixed wheel 12.4 in order to activate a fourth gear. A further fixed wheel 12.1 of the second transmission output shaft 12 is engaged with the drive wheel 19 of the differential gear 20.

The two fixed wheels 11.1, 12.1 of the transmission output shafts 11, 12, which are engaged with the drive wheel 19 of the differential near 20, are situated on a side of the transmission output shafts 11, 12 facing away from the internal combustion engine 2.

A further fixed wheel 12.2 that is engaged with an idler wheel 13.1 of the second transmission input shaft 13 is nonrotatably situated on the second transmission output shaft 12. In addition, vet a further fixed wheel 12.6 that is engaged with a second idler wheel 13.3 of the second transmission input shaft 13 is provided on the second transmission output shaft 12. Two further gears, which are usable, for example, for coupling the electric machine 4, may be provided via the idler wheels 13.1, 13.3 of the second transmission input shaft 13. The second transmission input shaft 13 is coupled via the planetary gear 17 to the machine shaft 14 of the electric machine 4, which is situated coaxially with respect to the second transmission input shaft 13.

The machine shaft 14 is nonrotatably connected to the sun wheel of the planetary gear 17. The second transmission input shaft 13 is nonrotatably connected to the annulus gear o he planetary gear. The planet wheel carrier of The planetary gear 17 having the planet wheels is fixed relative to a housing of the planetary gear 17. In this regard, the planetary gear 17 is operated in a dual-shaft mode in which only the sun wheel and the annulus gear are rotatable. The annulus gear of the planetary gear 17 is engaged with a fixed wheel 15.1 of the clutch shaft 15. This means that the clutch shaft 15 is coupled to the second transmission input shaft 13 via the fixed wheel 15.1 and the annulus gear of the planetary gear 17.

The manual transmission 4 thus has four selectively activatable gears for coupling the internal combustion engine 2 to the differential gear 20, and has two selectively activatable gears for coupling the electric machine 4 to the differential gear 20.

The block diagram according to FIG. 3 shows in a simplified manner the two various options for the power flow in the drive train 1. The power flow takes place from the internal combustion engine 2, via the first shift set 40 of the first and second gears, via the first transmission output shaft 11, to the differential gear 20, and then to the drive wheels 60. Via the shift set 50 of the third and fourth gears, the power flow takes place from the internal combustion engine 2, via the second transmission output shaft 12, to the differential gear 20. The power flow between the electric machine 4 and the differential gear 20 takes place via the second transmission input shaft 13 and the second transmission output shaft 12. Thus, in total only two interventions in the drive wheel 19 of the differential gear are necessary, which simplifies the bearing of the gear shafts.

A method for operating the drive train 1 is described in greater detail below, in which for selectively making a power flow possible between the electric machine 4 and the internal combustion engine 2, the shiftable separating clutch 5, which is situated coaxially with respect to the clutch shaft 15 and spaced apart from and in parallel to the first transmission input shaft 10, is actuated.

The internal combustion engine 2 may be started by means of the electric machine 4. A separate starter for starting the internal combustion engine 2 is not necessary. During a cold start, i.e., an operating situation in which neither the internal combustion engine 2 nor the electric machine 4 is active, initially the separating clutch 5 is engaged to establish an operative connection between the electric machine 4 and the internal combustion engine 2 via the planetary gear 17, the clutch shaft 15, the separating clutch 5, the idler wheel 15.1, the fixed wheel 10.1, and the transmission input shaft 10. The electric machine 4 is then operated as an electric motor, and the internal combustion engine 2 is tow-started. The speed of the internal combustion engine 2 is increased up to a predefined idle speed, and the internal combustion engine 2 is provided with an ignition pulse. It is also possible to start the internal combustion engine 2 when the drive train is in a purely electric driving mode in which the differential gear 20 is driven solely by the electric machine 4. In such a case, the electric machine 4 is transferred into a boost state in which it is operated as an electric motor and delivers power that is greater than the power required for the drive. The excess power may be diverted for tow-starting the internal combustion engine 2. For this purpose, the separating clutch 5 is engaged, resulting in a power flow between the electric machine 4 and the internal combustion engine 2.

When the motor vehicle is at a standstill, the electric machine 4 may be used to charge an energy store, in particular a battery, that is connected to the electric machine 4. For this purpose, all gears of the manual transmission are nonactively shifted. The separating clutch 5 is engaged so that power may flow from the internal combustion engine 2 to the electric machine 4 operated as a generator.

The gears of the second transmission input shaft 13, which are designed for the driving mode using the electric machine 4, and Which have a gear ratio that is smaller than the gear ratio of the first gear of the first transmission output shaft 11, may optionally be used for starting by means of the internal combustion engine 2. For this purpose, one of the two gears of the second transmission input shaft 13 is engaged. The separating clutch 5 is engaged and thus utilized as a starting clutch that connects the internal combustion engine 2, via the clutch shaft 15 and the second transmission input shaft 13, to the second transmission output shaft 12. The starting may optionally be assisted by the electric machine 4.

In an operating state in which the separating clutch 5 is disengaged, the power provided the internal combustion engine 2 and by the electric machine 4 may be combined. The four gears of the internal combustion engine 2, which are realized via the idler wheels of the first transmission output shaft 11 and the second transmission output shaft 12, and the two gears of the electric machine 4, which are realized via the idler wheels of the countershaft 13, may be selected as desired. When a gear is shifted on the transmission output shaft 11, 12, the speed of the internal combustion engine 2 is regulated and the resulting power gap is compensated for by the electric machine 4. When a gear is shifted on the second transmission input shaft 13, the speed of the electric machine 4 is regulated and the resulting power gap is compensated for by the internal combustion engine 2. Braking energy may be recovered as needed by operating the electric machine 4 as a generator.

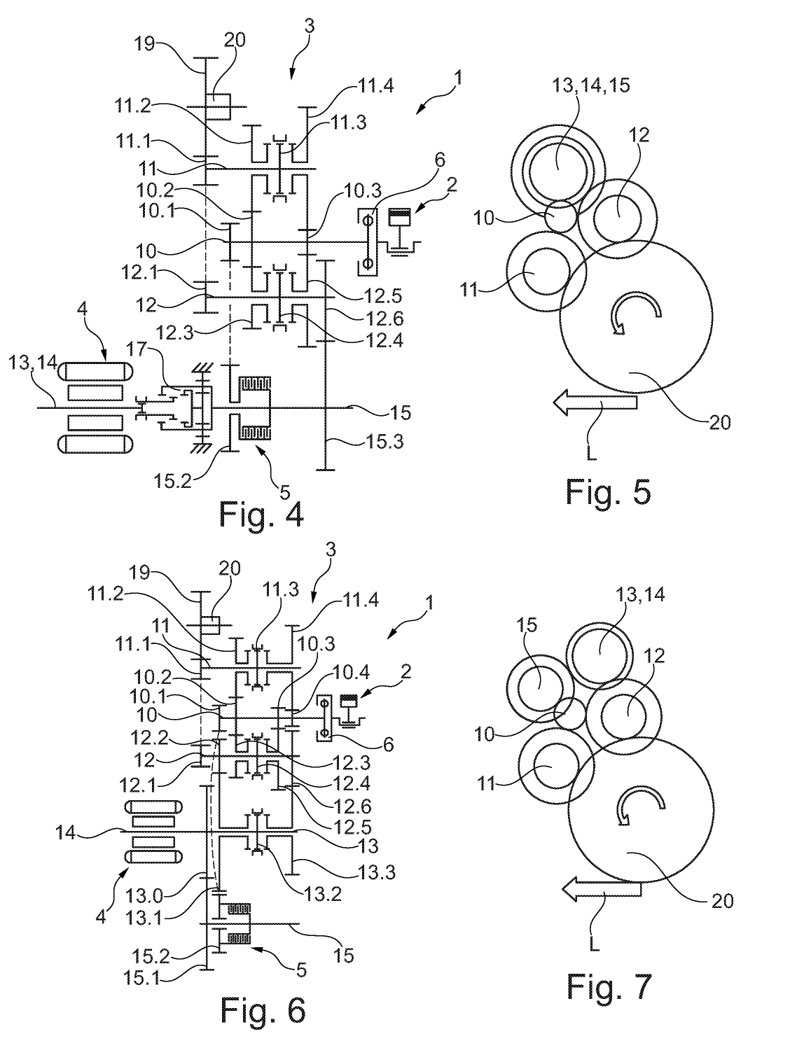

FIGS. 4 and 5 illustrate a second exemplary embodiment of a drive train 1 according to the invention. In this exemplary embodiment as well, the separating clutch 5 is situated coaxially on a clutch shaft 15, which is spaced apart from and parallel to the first transmission input shaft 10. In contrast to the first exemplary embodiment, for the drive train 1 according to the second exemplary embodiment the clutch shaft 15 connected to the separating clutch 5 is situated coaxially with respect to the machine shaft 14. The clutch shaft 15 bears a fixed wheel 15.2. The clutch shaft 15 is connected to a planetary gear 17 designed as a shiftable planetary gear. The shiftable planetary gear 17 has two selectable gear ratios, so that the shiftable planetary gear provides two shift stages via which the electric machine 4 may be coupled to the differential gear 20. In the second exemplary embodiment, the machine shaft 14 is nonrotatably connected to the second transmission input shaft 13, which is coupled to the shiftable planetary gear 17. The clutch shaft 15 is coupled to the second output shaft 12 via a fixed wheel 15.3 that is engaged with a fixed wheel 12.6 of the second output shaft 12.

In a first shift position of the shiftable planetary gear 17, the machine shaft 14 is connected to the sun wheel of the planetary gear 17. The annulus gear of the planetary gear 17 is fixed relative to the housing. In this case, the planet wheel set of the planetary gear 17 acts as a step-up for the clutch shaft 15 that is connected to the planet wheel carrier of the planetary gear 17. In this regard, a first gear may be realized.

In a second shift position of the shiftable planetary gear 17, the machine shaft 14 is connected to the planet wheel carrier of the planetary gear 17. A direct drive from the machine shaft 14 to the clutch shaft 15 is thus made possible. In this regard, a second gear may be realized.

In addition, the shiftable planetary gear may occupy a third, neutral shift position in which the machine shaft 14 is connected neither to the planet wheel set nor to the sun wheel of the planetary gear 17. This shift position is illustrated in FIG. 4. In this regard, freewheeling or a neutral position may be made possible. This position may be set to allow purely internal combustion engine start-up with the drive train 1, in which the electric machine 4 is decoupled, i.e., idle.

FIGS. 6 and 7 show a third exemplary embodiment of a drive train 1 according to the invention. In the third exemplary embodiment, the separating clutch 5 is situated coaxially on a clutch shaft 15, which is spaced apart from and In parallel to the first transmission input shaft 10. The clutch shaft 15 is also provided spaced apart from and in parallel to the machine shaft 14. In contrast to the first exemplary embodiment, no planetary gear is present in the drive train 1 according to the third exemplary embodiment. The machine shaft 14 is nonrotatably connected to the second transmission input shaft 13. The second transmission input shaft 13 is coupleable to the second transmission output shaft 12 via two selectable shift stages. In addition, the second transmission input shaft 13 has a first fixed wheel 13.0 that is engaged with a fixed wheel 15.1 of the clutch shaft 15. The clutch shaft 15 is connected to the separating clutch 5. The separating clutch 5 selectively disconnects or connects the clutch shaft 15 from/to an idler wheel 15.2 that is engaged with a first fixed wheel 10.1 of the first transmission input shaft 10.

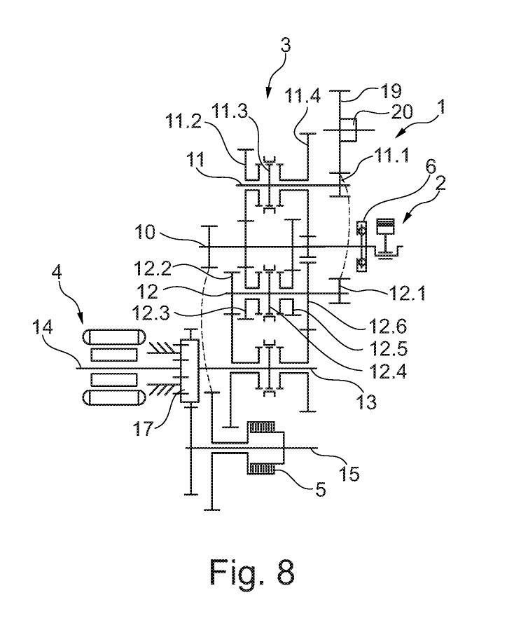

FIG. 8 shows a fourth exemplary embodiment of a drive train 1 according to the invention. In contrast to the first exemplary embodiment, in the drive train 1 according to the fourth exemplary embodiment the fixed wheels 11.1, 12.1 of the transmission output shafts 11, 12, which are engaged with the drive wheel 19 of the differential gear 20, are situated on a side of the transmission output shafts 11, 12 facing the internal combustion engine 2. Since the drive train 1 has exactly two interventions in the drive wheel 19 of the differential gear 20, there is a certain flexibility in the design of the transmission. Depending on the specific application requirements, the differential gear 20 may thus be situated either closer to the internal combustion engine 2, as shown in FIG. 8, or farther from the internal combustion engine 2, as shown in FIG. 1.

The above-described drive trains 1 for motor vehicles each have an internal combustion engine 2, an automated manual transmission 3, an electric machine 4, and a shiftable separating clutch 5 for selectively making a power flow possible between the electric machine 4 and the internal combustion engine 2. The automated manual transmission 3 has a first transmission output shaft 11 and a second transmission output shaft 12 that are operatively connected to a differential drive gear 19 of a differential gear 20. The internal combustion engine 2 has an output shaft 2.1 that is coupled without a separating clutch to a first transmission input shaft 10 of the manual transmission 3, wherein the separating clutch 5 is situated coaxially with respect to a clutch shaft 15 that is connected to the separating clutch 5 and is spaced apart from and in parallel to the first transmission input shaft 10. In addition, the clutch shaft 15 is spaced apart from and in parallel to the first transmission output shaft 11 and the second transmission output shaft 12. The axial length of the drive train 1 may be reduced as a result of this design. Moreover, it is possible to scale the electric machine 4 within wide ranges without having to adapt the layout of the automated manual transmission 3. The electric machine 4 does not have to be situated coaxially with respect to the internal combustion engine 2, so that the dimensions, in particular the diameter, of the electric machine 4 may be selected independently from those of the internal combustion engine 2.

### LIST OF REFERENCE NUMERALS

1 drive train

2 internal combustion engine

3 automated manual transmission

4 electric machine

5 separating clutch

6 vibration damper

10 transmission input shaft

10.1, 10.2, 10.3, 10,4 fixed wheel

11 transmission output shaft

11.1, 11. 3 fixed wheel

11.2, 11. 4 idler wheel

12 transmission output shaft

12.1, 12.2, 12.4, 12.5 fixed wheel

12.3, 12.5 idler wheel

13 transmission input shaft

13.1, 13.3 idler wheel

13.2 fixed wheel

14 machine shaft

14.1, 14.3 fired wheel

14.2, 14.4 idler wheel

15 clutch shaft

15.1, 15.3 fired wheel

15.2 idler wheel

17 planetary gear

19 drive wheel

20 differential gear

40 shift set

50 shift set

60 drive wheels

L vehicle longitudinal axis

1. A drive train for a motor vehicle, comprising:
an internal combustion engine,
an automated manual transmission,
an electric machine,
a shiftable separating clutch for selectively making a power flow possible between the electric machine and the internal combustion engine, and
a differential gear,
wherein the internal combustion engine has an output shaft that is coupled without a separating clutch to a first transmission input shaft of the automated manual transmission,
wherein the automated manual transmission has a first transmission output shaft and a second transmission output shaft that are operatively connected to a differential drive gear of the differential gear,
wherein in the separating clutch is situated coaxially with respect to a clutch shaft that is connected to the separating clutch and is spaced apart from and in parallel to the first transmission input shaft, and
wherein the clutch shaft is spaced apart from and in parallel to the first transmission output shaft and the second transmission output shaft.

2. The drive train according to claim 1, wherein the shiftable separating clutch is designed as a friction-locked shiftable separating clutch.

3. The drive train according to claim 1, wherein the differential drive gear of the differential gear is engaged with exactly two gearwheels to establish an operative connection with the first transmission output shaft and the second transmission output shaft.

4. The drive train according claim 1, wherein the automated manual transmission has a second transmission input shaft that is coupled without a separating clutch to a machine shaft of the electric machine,
wherein the automated manual transmission has a shiftable gearwheel stage via which the second transmission input shaft is coupleable to the first transmission output shaft or the second transmission output shaft.

5. The drive train according to claim 4, wherein the clutch shaft is spaced apart from and in parallel to the second transmission input shaft.

6. The drive train according to claim 4, wherein the first transmission input shaft, the second transmission input shaft, the first transmission output shaft, and the second transmission output shaft are each spaced apart from and in parallel to one another.

7. The drive train according to claim 4, wherein the second transmission input shaft is coupled to the machine shaft of the electric machine via a planetary gear, or that the second transmission input shaft is nonrotatably connected to the machine shaft of the electric machine.

8. The drive train according to claim 1, wherein the automated manual transmission has a gearwheel stage via which the clutch shaft is coupled to the first transmission output shaft or the second transmission output shaft.

9. The drive train according to claim 1, wherein the clutch shaft is situated coaxially with respect to a machine shaft of the electric machine.

10. The drive train according to claim 1, wherein the clutch shaft is spaced apart from and in parallel to a machine shaft of the electric machine.

11. The drive train according to claim 1, wherein the clutch shaft is coupled to the electric machine via a planetary gear.

12. The drive train according to claim 1, wherein the first transmission input shaft is coupled to the separating clutch via a gearwheel stage.

13. A method for operating a drive train of a motor vehicle, having an internal combustion engine and an automated manual transmission, wherein the internal combustion engine has an output shaft that is coupled without a separating clutch to a first transmission input shaft of the automated manual transmission, wherein the automated manual transmission has a first transmission output shaft and a second transmission output shaft that are operatively connected to a differential drive gear of a differential gear, and an electric machine, wherein for selectively making a power flow possible between the electric machine and the internal combustion engine, a shiftable separating clutch that is situated coaxially with respect to a clutch shaft and spaced apart from and in parallel to the first transmission input shaft is actuated, wherein the clutch shaft is spaced apart from and in parallel to the first transmission output shaft and the second transmission output shaft.
